(19) United States
(12) Patent Application Publication
(10) Pub. No.: US 2010/0252636 A1
(43) Pub. Date: Oct. 7, 2010

(54) Optical recognition code, method for marking the same, method for reading out the same, and articles marked with the same

(75) Inventor: Akiteru Kimura, Tokyo (JP)

Correspondence Address: OLIFF & BERRIDGE, PLC, P.O. BOX 320850, ALEXANDRIA, VA, 22320-4850, US

(73) Assignee: B-CORE INC., Tokyo (JP)

(21) Appl. No.: 12/662,281

(22) Filed: Apr. 8, 2010

Related U.S. Application Data
(63) Continuation-in-part of application No. PCT/JP2008/070305, filed on Nov. 7, 2008.

(30) Foreign Application Priority Data
Nov. 9, 2007 (JP) 2007-292273
Aug. 1, 2008 (JP) 2008-199785
Nov. 6, 2008 (JP) 2008-284986

(51) Int. Cl. G06K 7/10; G06K 19/06

(52) U.S. Cl. 235/469; 235/494

(57) ABSTRACT

A method that lays a certain restriction on a distance between color areas and carries out “cutting out” and “sequence recognition.”

In an optical recognition code which aligns a plurality of cells to predetermined color is affixed and denotes a data by a sequence of colors, distance between the cells is stipulated to allow an easier reading-out of the code. A distance between the cells contiguous to each other is > a predetermined minimum value and < a predetermined maximum value. The distance between one of the cells and another of the contiguous cells is shorter than a distance between the one of the cells and another of the noncontiguous cells. Under these conditions, it is possible to read out the optical recognition code in the sequence of the cells by sequentially tracing the near-positioned cells with the distance as a clue.

### BACKGROUND OF THE INVENTION

1. Technical Field

The present invention relates to optical recognition codes and especially to optical recognition codes which, in principle, denote data only by transition, change, combination, and sequence of color. More particularly, it relates to a method for reading out the 1D color bit code (Japanese Patent Application No. 2006-196705) invented by the present inventors and details of a code symbol form suitable for the method.

2. Background Art (Description of the Related Art)

Conventionally, optical recognition codes have been widely utilized. As representative conventional optical recognition codes, there are known so-called (one-dimensional) barcodes, two-dimensional barcodes (QR Code, registered trademark), and the like.

In order to increase information amount as well as to allow the code to be marked even on concave-convex surfaces, the present inventors have uniquely invented an optical recognition code which is called 1D color bit code (Japanese Patent Application No. 2006-196705).

1D Color Bit Code

According to the 1D color bit code, because there is applied an undemanding restriction on size and shape of the areas occupied by each color, it is possible to mark the optical recognition code even on concave-convex surfaces and flexible materials.

The 1D color bit code is configured to return a digital value which is determined by an arrangement of a plurality of colors (signal colors: marking colors). The basic configuration is an arrangement (=code symbol) of a series of aligned colors (signal colors: marking colors).

In addition, the applicants of the present application have applied for patents as below with respect to the 1D color bit code.

Japanese Patent Application No. 2007-130504: METHOD FOR CUTTING OUT OPTICAL RECOGNITION CODE

Japanese Patent Application No. 2007-258723: METHOD FOR COLLECTIVELY READING IN OPTICAL RECOGNITION CODE AND DISPLAYING THE SAME

Explanations of Technical Terms

Some technical terms will be explained with respect to the optical recognition code.

Code symbol: A “code symbol” refers especially to a particular individual optical recognition code per se which is an assembly or a group of images for denoting a predetermined data. Sometimes, it is also referred to simply as a “symbol”. Further, sometimes the “code symbol” per se is also referred to as a “tag” for convenience sake. However, a tag refers basically to a medium which is affixed to an article (mark object); for example, a price tag, a product tag, and the like.

Mark object: A “mark object” refers to an article or an object to which a code symbol of the optical recognition code is affixed.

Marking: “Marking” refers to the performance of affixing a code symbol of the optical recognition code to a mark object. These correspond to preferred examples of marking: the process of directly “printing” a code symbol on a mark object, the behavior of applying a “self-adhesive sticker” or a tag to which a code symbol is affixed to a mark object, and the like. Especially, if the mark object is an article or a product for sale, the tag to which a code symbol is affixed corresponds to a “price tag”, a “brand tag”, and the like. It is now widely practiced that the code symbol is affixed to such a “price tag”, which is then applied to an “article”. In recent years, plastic wires are often utilized in this application. Those “applications” are also preferred examples of the aforementioned “marking”.

Marking color: A “marking color(s)” refers to one or more color(s) utilized in the code symbol. The marking color is also referred to as a “signal color”.

Medium: A “medium” refers to the means or material with which a mark object is marked. In particular, it corresponds to the ink utilized in marking, a price tag applied to the mark object, a product tag, and the like. The “ink” utilized in direct printing is an example of the medium. Further, the “product tag” or “price tag” is another example of the medium in the case of “applying” the product tag to which the code symbol is affixed. Furthermore, the aforementioned self-adhesive sticker also corresponds to a preferred example of the “medium”.

Quiet zone: A “quiet zone” refers to areas the color of which is not a marking color, including the code symbol border but excluding the code symbol area.

A Simple Explanation about 1D Color Bit Code

Now, an explanation will be given about the 1D color bit code developed by the present inventors. A 1D color bit code:
I. is a series of areas (cells) of predetermined colors arranged in a line or row (=a “cell alignment”);
II. utilizes a plurality of colors which are respectively affixed to each cell;
III. is such that the cells are not included in each other. That is, a cell does not include another cell;
IV. is such that the number of the cells composing the alignment is a predetermined number; and
V. is such that not an identical color but different colors must be affixed to the cells which are contiguous to each other.

The 1D color bit code is formed basically under those conditions.

Of course, the number of cells, the sort of colors actually utilized, and the like differ in each application.

Further, with the 1D color bit code, the code symbol is read out by tracing the color areas which are candidates able to become the cells on an image. Such processing is a kind of image processing which focuses on a predetermined color area, searches for another marking color area which is contiguous to the predetermined color area, focuses then on the area found by the search, and searches further for another area which is contiguous to the found area so as to find another cell. Such a process is repeated to trace the areas for extracting an alignment of the cells (alignment of the colors) composing the 1D color bit code. Based on the extracted alignment of the colors of cells, the data denoted by the alignment is thus acquired.

Therefore, there are basically no restrictions on shape and the like. The only fundamentally important thing is the connection state (contiguity state) of color areas, which do not receive any specific restrictions on size and shape.

Because there are no restrictions of that kind, it is possible to read out the 1D color bit code affixed even to such an object (referred to as a mark object) as with flections and distortions.

Relationship Between “Cell” and “Color Area”

Both of them refer to “area” but are different in meaning as follows.

First, a cell refers to each color area which composes the optical recognition code.

On the other hand, a color area refers to each predetermined color area in a photographed image data. The color area is certified as a “cell” composing the optical recognition code if predetermined conditions are met. Of course, in an image data, there are also color areas turning out to be “backgrounds” which cannot become cells.

That is, in an image data, there are two kinds of “color areas”: those which become “cells” and those which turn out to be backgrounds excluded from the optical recognition code.

Conventional Related Art

Hereinafter, a few conventional patent technologies will be described.

For example, the following Patent Document 1 has disclosed a technology of printing intra-office codes by means of a barcode with ID codes printed by four-state bar and in accordance with bar-no-bar method so as to prevent incomplete printing.

Further, the following Patent Document 2 has disclosed a technology by which the barcode can be read out even if there are scratches or abrasions in the object taken in by a CCD camera or even if there are missing portions in the barcode.

Furthermore, the following Patent Documents 3 and 4 have disclosed a thermal recording medium which includes a chromogenic compound with a near-infrared-absorbing ability in the thermally chromogenic layer and which has a chromogenic pattern of so-called KARURA code. It is described that as a result, it is possible to read out the code even if there are some missing portions in the automatic recognition code.

[Patent Document 1] Japanese Unexamined Patent Application Publication No. 2006-095586

[Patent Document 2] Japanese Unexamined Patent Application Publication No. 2000-249518

[Patent Document 3] Japanese Unexamined Patent Application Publication No. 08-300827

[Patent Document 4] Japanese Unexamined Patent Application Publication No. 08-185463

### DISCLOSURE OF THE INVENTION

### Summary of the Invention

### Problems to be Solved by the Invention

(a) The First Problem

Now, a 1D color bit code is, as described above, formed by an alignment of a plurality of colors. When the 1D color bit code is taken in by a CCD camera and the like, the image including the code symbol is usually received together with the background.

On the other hand, the characteristic of the 1D color bit code (decoding method) resides in tracing the continuation of colors (“cutting out”+“sequence recognition”). Therefore, if the background colors exist randomly, the tracing will be impossible. Further, it would be easy to anticipate that if a marking color appears in the background colors, the tracing may be mistakenly carried out among the background colors.

Further, under some circumstances, some marking colors may be missing due to uncleanness or illumination problems. In this case, it is possible, though, to restore the data completely or incompletely by introducing technologies for error detection and correction through the code system.

However, such error correction technology and error detection technology are based on the premise that except the missing portions, the remaining code portions are completely read out. That is, for example, two error bits can be detected out of 10 bits, etc.

With the 1D color bit code, however, if there are missing portions, area tracing often cannot be carried out thereafter. This is because area tracing is based on the premise that the areas are continuous. Thereby, if the tracing fails on the way, there are no ways and means to restart the tracing automatically. Therefore, if the tracing cannot be carried out due to missing of code portion, technologies of “error detection” and “error correction” will make no sense at all.

Therefore, it is necessary to accomplish a mechanism with which the tracing can be continued even if there is missing of code portion in the optical recognition code which denotes a data by transition or change of color such as the 1D color bit code.

Accordingly, a first object of the present invention is to provide a 1D color bit code which can be traced even if some code portions are missing, and a method for tracing the code.

(b) The Second Problem

Meanwhile, the present inventors have already developed and applied for another patent a principled method for the “cutting out” and “sequence recognition” processes of a code symbol, as described above, with respect to the 1D color bit code (see the above Patent Document 1).

The cutting-out already developed by the inventors is based on “boundary condition” of a color area. For the 1D color bit code, the cutting-out based on the “boundary condition” can be, viewing from the definition, regarded as essential.

That is, the cutting-out based on the boundary condition is a method of following up the colors of contiguous color areas. Thus, it is, as described above, a principled and essential cutting-out method for the 1D color bit code which receives no restrictions on position and size of the color areas.

However, for searching another color area contiguous to that of no restrictions on shape and size, a complicated process is often necessary in principle. First, it is necessary to establish color areas based on the colors from a captured image. Further, for checking whether they are in a contiguous or noncontiguous state, it is necessary to trace the entire boundary around each color area and search the color area contiguous thereto (in principle). Therefore, a large amount of calculation is required. Besides, because being only one pixel apart is also considered as “noncontiguous”, it is necessary to acquire an accurate image.

The 1D color bit code receives no specific restrictions on shape, size, and position in principle, thereby enjoying a high degree of freedom. In proportion to that, the processes of imaging and reading-out (cutting out+sequence recognition) tend to be complicated as described above.

(b-2)

As a result, depending on purposes, usages, and circumstances, a method for simplified “cutting out” and “sequence recognition” may also be desired.

For example, it is conceivable to apply some “restriction or limitation” and “allowance” to the 1D color bit code so as to simplify the reading-out process.

Accordingly, the present invention proposes a method for carrying out “cutting out” and “sequence recognition” based on the distance between the color areas with a certain restriction laid thereon.

Further, in this case, since the color area is not recognized on the basis of the aforementioned “boundary condition”, the condition that the presently focused-on color area is in connection with a color area different in color may not be necessarily met.

In the cutting-out method based on the principled “boundary condition” described above, because a contiguous identical color is, of course though, necessarily regarded as the identical color area, it is not assumed that color areas of an identical color have a boundary therebetween.

Therefore, it is necessary to reasonably deal with identical color. Detailed explanations will be given thereinafter.

Accordingly, a second object of the present invention is to realize a method for carrying out “cutting out” and “sequence recognition” in an easier manner based on the distance between the color areas with a certain restriction laid thereon as proposed hereinabove.

In the embodiments which will be described hereinafter, requirements necessary for the tracing method and the code symbol therefor will be illustrated in company with specific examples.

### Means for Solving the Problems

(1) In order to solve the above problems, the present invention provides an optical recognition code disposing a plurality of cells to each of which a predetermined color is affixed and denoting a data by a sequence of the colors affixed to the cells, wherein a distance between the cells contiguous to each other is more than or equal to a predetermined minimum value and less than or equal to a predetermined maximum value; and the distance between one of the cells and another of the contiguous cells is shorter than a distance between the one of the cells and another of the noncontiguous cells.

Aspect (1) of the present invention is with respect to the first and third conditions which will be described hereinafter.
(2) Further, the present invention provides an optical recognition code disposing a plurality of cells to each of which a predetermined color is affixed and denoting a data by a sequence of the colors affixed to the cells, wherein a distance between the cells contiguous to each other is more than or equal to a predetermined minimum value and, less than or equal to a predetermined maximum value; and a distance between one of the end point cells located at either of the two ends of the optical recognition code and another of the noncontiguous cells is more than the predetermined maximum value.

Aspect (2) of the present invention is with respect to the first and tenth conditions which will be described hereinafter.
(3) Further, the present invention provides an optical recognition code disposing a plurality of cells to each of which a predetermined color is affixed and denoting a data by a sequence of the colors affixed to the cells, wherein a distance between the cells contiguous to each other is more than or equal to a predetermined minimum value and less than or equal to a predetermined maximum value; the distance between one of the cells and another of the contiguous cells is shorter than a distance between the one of the cells and another of the noncontiguous cells; and a distance between one of the cells and another of the cells between which yet another of the cells is sandwiched is less than or equal to the predetermined maximum value and shorter than a distance between the one of the cells and another of the noncontiguous cells.

Aspect (3) of the present invention is with respect to the first, third, fourth and sixth conditions which will be described hereinafter.
(4) Further, the optical recognition code according to any one of the above Aspects (1) to (3), wherein the minimum value and the maximum value are provided by an absolute dimension or a relative dimension.

Herein, the relative dimension refers, as will be described hereinafter, to a relative representation of dimension by a ratio between the maximum and minimum values and the like.
(5) Further, the present invention provides a method for marking a mark object with the optical recognition code according to any one of the above Aspects (1) to (4), the method comprising the step of disposing the optical recognition code on the mark object at such a position that a minimum distance between any of the plurality of cells which compose the optical recognition code and a color area which does not compose the optical recognition code on the mark object becomes more than the predetermined maximum value.
(6) Further, the optical recognition code according to any one of the above Aspects (1) to (4), wherein the distance between the cells is a minimum interspace between the cells, respectively.
(7) Further, the optical recognition code according to any one of the above Aspects (1) to (4), wherein the distance between the cells is an average interspace between the cells, respectively.
(8) Further, the optical recognition code according to any one of the above Aspects (1) to (4), wherein the distance between the cells is a distance between basing points of the cells, respectively.
(9) Further, the present invention provides a method for reading out the optical recognition code according to any one of the above Aspects (1) to (4), the method comprising the steps of:
(9a) imaging an image including the optical recognition code and obtaining an image data; and
(9b) dividing the obtained image data into color areas of each color, extracting based on color the color areas which are candidates of the cells composing the optical recognition code from the color areas, tracing the extracted candidates of the cells based on the distance therebetween, and restoring the data denoted by the optical recognition code based on the sequence of the cells obtained from the tracing result,
   wherein in step (9b), when the color areas of an identical color are continuously aligned, they are considered as to form a single one of the cells.
(10) Further, the optical recognition code according to any one of the above Aspects (1) to (4), wherein the number of the cells composing the optical recognition code is predetermined.
(11) Further, the method for marking a mark object with the optical recognition code according to the above Aspect (5), wherein the distance between the cells is a minimum interspace between the cells, respectively.
(12) Further, the method for marking a mark object with the optical recognition code according to the above Aspect (5), wherein the distance between the cells is an average interspace between the cells, respectively.
(13) Further, the method for marking a mark object with the optical recognition code according to the above Aspect (5), wherein the distance between the cells is a distance between basing points of the cells, respectively.
(14) Further, the method for reading out the optical recognition code according to the above Aspect (9), wherein the distance between the cells is a minimum interspace between the cells, respectively.
(15) Further, the method for reading out the optical recognition code according to the above Aspect (9), wherein the distance between the cells is an average interspace between the cells, respectively.
(16) Further, the method for reading out the optical recognition code according to the above Aspect (9), wherein the distance between the cells is a distance between basing points of the cells, respectively.
(17) Furthermore, the present invention provides an article being marked with the optical recognition code according to any one of the above Aspects (1) to (4).

### EFFECTS OF THE INVENTION

As described hereinabove, according to the present invention, because a maximum value and a minimum value are introduced into the inter-cell distance, it is possible to provide an optical recognition code which can be read out by tracing based on distance.

As a result, it is possible to realize an optical recognition code which can be read in an easier manner, etc.

Further, it is yet possible to provide an optical recognition code in which tracing can be continued even if there is missing of cell.

### DETAILED DESCRIPTION OF THE INVENTION (BEST MODES FOR CARRYING OUT THE INVENTION)

Hereinafter, descriptions will be made with respect to preferred embodiments of the present invention in reference to the accompanying drawings.

### Embodiment 1

### Discrete 1D Color Bit Code

In Embodiment 1, descriptions will be made with respect first to a discrete 1D color bit code which distinguishes the distance between color areas to carry out “cutting out” and “sequence recognition”, and next to a method for decoding the same.

1-1 Concept of Discrete 1D Color Bit Code (the Purpose and Related Art)

A modification of the 1D color bit code is a code in which there is a predetermined rule on each distance between “one of the color areas which compose the color bit code” (=a “cell”) and another. A specific reading-out method is to compare each distance between the respective color areas acquired from the result of processing a captured image with a predetermined value so as to recognize the cell alignment of the color bit code.

Besides, in Embodiment 1, the following conditions are to be met for a successful recognition of the cell alignment of the discrete color bit code.
I. No mistaken tracing from a cell to a “non-cell color area” (which cannot become a cell).
II. A contiguous cell is necessarily traced (without stop on the way of tracing).
III. A noncontiguous cell is not mistakenly traced (to keep the correct sequence).

If the above conditions are not met due to noises, marking defects, and the like, it is referred to as “cell alignment is not recognizable”.

Further, supposing there are some missing color areas and error correction is carried out to make up for them, it is still necessary, of course, to meet the above conditions even under such circumstances (there are missing colors).

Further, as a basic rule for the 1D color bit code, it is set up that areas of an identical color should not be contiguous to each other. This is a necessary condition for the tracing process and should also be met in Embodiment 1.

1-2 Configuration

In the embodiment, the discrete 1D color bit code will be described as an application modification of the 1D color bit code.

A characteristic of the discrete type is that an upper limit and a lower limit are imposed on the distance between the respective cells (color areas).

That is, in the 1D color bit code proposed earlier by the present inventors, cells are always in contiguous contact with each other. However, in the discrete 1D color bit code, cells may also be apart from each other, and the distance therebetween is determined within a certain range.

In particular, the discrete type is different from the basic 1D color bit code in the aspects as below.

<<The First Condition>>

An upper limit and a lower limit of the distance d between the respective cells composing the code symbol are determined.

The above condition is added. That is, the distance d between every contiguous “cells” composing the code symbol is predetermined as: a1≦d≦a2.

This distance condition is “the first condition” of the discrete 1D color bit code proposed by the embodiment. It will be described again in detail thereinafter.

Further, the inter-cell distance d may be determined in various manners. For example, the distance between centroids is preferable. Further, the distance d may also be preferably determined as a minimum interspace between the cells (color areas). This will also be described in detail thereinafter.

1-3 Merit

In the 1D color bit code, since there is a requirement that cells (color areas) be always contiguous to each other, searching must be carried out under boundary conditions. Further, if there are cells being apart even a little, it is considered as noncontiguous at that point, and thereby the tracing of cell may conceivably be terminated.

In contrast, since the discrete 1D color bit code allows a certain range (a1≦d≦a2) of distance between the respective cells (color areas), it has a characteristic that areas can be traced and read out even if there is some change in distance between the cells due to print scratches or abrasions and the like.

Further, since the cells are apart from each other, it is unnecessary to search under the boundary conditions but necessary instead to examine whether there are any other cells in the predetermined distance range. This examination is a process of searching a certain range of distance and thus becomes formulaic. Hence, in comparison with the process of tracing the atypical boundary of the color area which may form a cell one pixel by one pixel, the examination may be a comparatively simple process and can possibly contribute to reduction in processing time as well.

FIG. 1 shows an example of such a discrete 1D color bit code.

FIG. 1 illustrates an image of a discrete 1D color bit code formed of n cells and other color areas which do not compose the code symbol.

In FIG. 1, it is assumed that, the code symbol is composed of n “cells”, and the distance d between every contiguous cells is, as described hereinbefore, predetermined as a1≦d≦a2. Herein, a1 is a minimum value of the distance and a2 is a maximum value of the distance.

1-4 Conditions for Successful Tracing

Now, in such a discrete 1D color bit code of the embodiment, the n cells are referred to respectively as C1, C2, C3, . . . , and Cn, which form the optical recognition code denoting a data by the sequential arrangement.

Then, in description of the present invention, dk represents the distance between the cell Ck and the cell Ck+1.

That is,

d1 represents the distance between C1 and C2;

d2 represents the distance between C2 and C3; . . . ; and

dn−1 represents the distance between Cn−1 and Cn;

Then, the first condition for distinguishing a “cell” from the surrounding color areas so as to be able to trace according to the sequence can be, as has been described so far, written in the following manner.

<<The First Condition>>(Rewritten)

a1≦d1, . . . , dn−1≦a2

That is, the distance between the cells contiguous to each other is, as has been already described, within the range between the predetermined minimum value a1 and maximum value a2.

Since the color areas of “non-cell” which do not compose the code symbol do not necessarily meet this condition, they can be excluded from the cell candidates of the code symbol.

Further, the second condition for distinguishing a “cell” from the surrounding color areas so as to be able to trace according to the sequence can be written in the following manner.

### <<The Second Condition>>

The distances D1, . . . , and Dn between each “cell” and the nearest non-code-symbol color area should meet: either

(the second condition a) D1, Dn>a2, or as another way of thinking,

(the second condition b) dk−1, dk Dk (k=1 to n).

In either of the conditions, the distance between a “cell” and a contiguous cell is necessarily shorter than that between the “cell” and a surrounding non-cell color area; thereby a non-cell color area will not be mistakenly traced.

Further, the third condition for distinguishing a “cell” from the surrounding (other non-cell) color areas so as to be able to trace according to the sequence can be written in the following manner.

### <<The Third Condition>>

The distances between No. k cell and the contiguous cells on both sides, dk−1 and dk, should meet the following conditions.

If d(m:n) represents the distance between No. m cell and No. n cell, then,

dk−1<d(1:k), d(2:k), . . . , d(k−2:k); and

dk−1<d(k+2:k), . . . , d(n:k).

That is, with respect to the distance between the cell Ck and another cell, the distances between the cell Ck and the cells on both sides must be shorter than those between the cell Ck and any other cells.

The above formula shows a condition that the distance dk−1 is shorter than any other distances except the distance dk. This also applies to the distance dk. As a formula, it is necessary to establish the following one, which is completely the same as the above.

dk<d(1:k), d(2:k), . . . , d(k−2:k); and

dk<d(k+2:k), . . . , d(n:k).

These formulas mean, in a word, that it is necessary to establish a relationship that the distances dk and dk−1 are shorter than those between the cell Ck and any other cells.

If the third condition is met, it is possible to carry out tracing according to the desired sequence predetermined by the code symbol by tracing over the short distance to restore the code symbol value.

In contrast, if the third condition is not met, the correct cell sequence of the code symbol cannot be restored by the process of tracing cells over the short distance. Thereby, it is possible to recognize the code symbol in a wrong sequence so as to restore a wrong data.

By means of a tracing algorithm which meets the above conditions (the first, second and third conditions), it is possible to trace the color bit code correctly.

1-5 Dealing with Contiguous Areas of an Identical Color

Besides, the 1D color bit code system proposed by the present inventors in Japanese Patent Application No. 2006-196705 does not allow areas of an identical color to be contiguously aligned. This is because the data there is denoted through color changes, which are detected in the decoding process. In other words, if there are contiguous areas of an identical color, it is difficult in principle to distinguish the respective areas because they are recognized as a single area.

In contrast, in the discrete 1D color bit code of the embodiment, since contiguous areas are not necessarily in contact, areas of an identical color can be allowed to be “contiguous”.

However, from the point of view of keeping a compatibility with the conventional 1D color bit code, the embodiment is described with examples which do not allow areas of an identical color to be continuously aligned (that is, to be contiguous).

Therefore in the embodiment, in order to keep this rule, if two or more areas of an identical color are continuously detected, they will be considered as a single color area (=a single cell).

1-6 Unramified Structure

The 1D color bit code is characterized by tracing unramified aligned cells. Therefore, in such a case as there are three or more areas in contact with each other, it is possible to determine the areas as non-cells.

However, as in the embodiment, since each color area is independent like the discrete 1D color bit code and the cell alignment is determined on the basis of the distance between the respective color areas, instead of the determination of “being contiguous”, the concept of “distance” becomes very important. The next section will give a detailed explanation on the concept of distance.

1-7 Definition of the Concept of Distance Between Color Areas:

### Minimum Interspace

There are various definition methods as to how to determine the distance between color areas.

In the embodiment, as a preferable example, the “distance” between color areas is defined as a “minimum interspace” between the areas. In addition, if the minimum value of distance (minimum interspace) is set to zero, it is equivalent to tracing the 1D color bit code under boundary conditions.

This is equal to setting a1 to zero when a1 is utilized as the minimum value of distance between the color areas which are cells while a2 as the maximum value of distance.

1-7-1 Definition of Minimum Interspace

Herein, the minimum interspace between a first color area and a second color area refers to the distance between the pixels which are selected such that the distance between those two pixels becomes the shortest when one of the pixels is taken out of the first color area whereas the other is taken out of the second color area. Further, the term referred to herein as the distance between the pixels is the square root of the sum of squares of the difference between the coordinate values of the two pixels.

For example, when the coordinates of a pixel in the first area are set as (x1, y1) and the coordinates of a pixel in the second area as (x2, y2), the distance between them is:

Distance=((x1−x2)̂2+(y1−y2)̂2)^{1/2}

A minimum interspace is a distance between the areas in which the pixels are selected such that the distance becomes the shortest.

However, it should be appreciated that the distance (the minimum interspace between color areas) is not, in origin, a rule with respect to the dimension of a real-world code symbol but a rule or value which can be applied only as the code symbol is in the state of being captured (i.e., the image data).

Therefore, when rules such as the minimum distance a1 and the maximum distance a2 are laid on an image data, an appropriate rereading (adjustment) is required in actually marking the code symbol on articles. Because the rereading varies with the size, resolution, image quality and the like of a photographed image data, the details of rereading are, in reality, decided according to the utilized CCD camera, optical system, marking precision, the size of image data, resolution, and the like.

In this manner, in the embodiment, the minimum value a1 and the maximum value a2 correspond to the imaging results and serve as an optical angle viewed from the actual imaging spot. Thereby, they are in nature such that the results projected on the code symbol are applied to the code symbol based on the optical specifications, distances, and code symbol inclinations.

In addition, not only the minimum interspace but other definitions may also be preferably utilized for the distance between color areas. For example, it is also preferred to utilize the distance between the centroids of the respective color areas.

1-8 Practical Rules on the Code Symbol

Hereinafter, consideration will be given to the case of actually marking the code symbol on a mark object.

Herein, there will be given an example which considers the values of the above a1 and a2 not as absolute values but as variations in the distance between the cells composing the code symbol.

The magnification coefficient of the above a1 and a2 against an actual mark object is, for convenience sake, set as “b”.

Then, utilizing the b, the above a1 and a2 become “b·a1” and “b·a2” on the surface of the actual mark object, respectively. Thus, it is possible to view that the minimum interspace between the cells varies (disperses) in the range from “b·a1” to “b·a2”.

That is, it is possible to detect and extract the code symbol composed of a color area group by considering the color area group of a predetermined number (cell number) contained within the variation range as the cell group. In this manner, it is also preferred to adopt the decoding method (idea) which distinguishes the color areas forming the cells from those not forming the cells (referred to as non-cells).

Further, when the inter-cell distance is defined as the “minimum interspace” between the cells, it is conceivable that the possibility of distinguishing non-cell areas increase without taking the magnification condition into account if the above a1 and a2 are set to a value extremely close to zero. This is because when the interspace is almost zero, no matter what value the magnification is, it is conceivable that the interspace is in the same manner almost zero in the practice of marking on an actual mark object, while the distance between non-cells remains at a certain value.

Further, when the mark object which is a photograph object is located substantially far away, there is not much influence on photograph magnification even if the position of the camera which is the photograph means changes a little. Therefore, since the so-called distance ratio does not change greatly, it is also possible to determine the abovementioned ratio based merely on the condition on the photograph side, that is, the condition on the camera side.

1-8b Application by Utilizing the Rules by Ratio

In this manner, it is useful to determine the minimum value al and the maximum value a2 of the distance. However, because the value of the above b varies with the optical system, CCD, pixel number, and the like in imaging, it is often preferable, in reality, to determine them with the ratio (a2/a1) between the minimum and maximum values.

Especially, when the optical recognition code is marked on a mark object, it is also not very useful to determine absolute values (a1: 1 mm, a2: 10 mm, and the like) of the minimum value a1 and the maximum value a2. In practice, it is also preferred to determine a ratio between the minimum and maximum values such as a2/a1=10, and then replace it by specific values in accordance with the actual mark object.

Then, it is a preferred application to configure such that the specific value of the above b is determined in reading out the code.

### 1-9 Conclusion

Now, in whichever cases, in Embodiment 1, the code symbol is considered as a group of color areas of a predetermined number (cell number) in which the distance between color areas is between the minimum distance a1 and the maximum distance a2.

Embodiment 1 is characterized by, in this manner, determining whether a color area is a cell which composes the code symbol or a non-cell (background cell) which does not compose the code symbol, according to the distance between the color areas.

As a result, in comparison with the conventional reading-out method, it is possible to make an attempt on simplification of the determination algorithm, thereby allowing a further accurate determination to be made quickly. In the conventional 1D color bit code, it was, in principle, necessary to make the determination by tracing all the areas contiguous to a color area. Further, the tracing had to be carried out along the atypical boundary lines of color areas and thereby tended to become a complicated process. In comparison with that, in the embodiment, since it is sufficient to search the areas positioned at a predetermined distance only, a further simplified computerized processing becomes highly possible.

1-10 Condition for Forming a Discrete 1D Color Bit Code

So far, there have been described various conditions for a successful tracing just as indicated by the title of 1-4. The successful tracing conditions are a little different from the condition for forming a discrete 1D color bit code in the following aspects.

For example, the aforementioned second condition is with respect to a relationship between the discrete 1D color bit code and the surroundings in the marking rather than for the discrete 1D color bit code per se. In this meaning, it is, strictly speaking, a marking condition.

Therefore, the requirements for the discrete 1D color bit code proposed in the embodiment are as follows, excluding the second condition.

<<The First Condition>>(Rewritten)

The distance between contiguous cells is not less than the minimum value a1 and not more than the maximum value a2.

<<The Third Condition>>(Rewritten).

Viewing from the cell Ck, except the cell Ck+1, the cell Ck−1 is the nearest cell. In the same manner, viewing from the cell Ck, except the cell Ck−1, the cell Ck+1 is the nearest cell. k is an integer from 2 to n−1.

This condition means, in short, that the nearest and the second nearest cells to the cell Ck are the contiguous cells Ck−1 and Ck+1. That is, it indicates that cells which should be connected to a cell are the two nearest cells. Herein in addition, there is a premise that Ck is not an end cell. An end cell is connected to the nearest cell and thus has no direct relations with the third condition.

Reading-Out Process Flow

Generally, the process flow as below is followed to read out the discrete 1D color bit code formed or marked under the above conditions.

Step 1: Capturing (imaging) an image including a code symbol.

Step 2: Regionalizing the obtained image data into each color based on the colors.

Step 3: Tracing the areas of marking colors utilized in the code symbol to extract the connecting relation of each area, wherein the tracing is carried out based on the distance between the areas, and the color areas are traced based on the premise that areas within the range from the minimum value a1 to the maximum value a2 are contiguous areas.

Step 4: Determining from the tracing results which areas compose the code on the basis of the colors utilized in the code and the extracted or identified connecting relation of each color area (the number of cells), wherein from the color areas which are determined as of the optical recognition code, the color alignment is extracted so as to restore the original data therefrom.

The reading-out process is generally carried out in this manner. As has already been described, however, it is conceivable that the term “distance” used herein may be defined in various manners.

### Embodiment 2

### Dealing with Missing of Cell

Embodiment 1 has proposed a method for tracing the color areas which will become the cells composing a code symbol on the basis of the distance between the color areas, and a new optical recognition code (discrete 1D color bit code) which corresponds to the method.

In Embodiment 2, a description will be made with respect to missing of cell in the discrete 1D color bit code.

Consideration will be given only to the case in which one cell is missing at any place in recognition for some reasons such as uncleanness on the surface of a mark object and the like. Cases in which two cells or more are missing will not be considered.

As described hereinabove, if the cells other than the missing cell can be traced and read out, it is possible to restore the missing cell by utilizing the existing so-called error correction and error detection technologies. In order to apply such error correction technologies, it is necessary to correctly read out the cells other than the missing cell.

That is, it is necessary to consecutively trace the cells located before and after the missing cell. This requires that the conditions described in Embodiment 1 still be met even though there is a missing cell, and no tracing be mistakenly directed to non-cell areas from the missing portion.

2-1 Conditions for Successful Tracing even if One Cell is Missing

These conditions will be described in reference to FIGS. 2 and 3.

In FIG. 2, s1, s2, . . . , and sn−2 refer to the distances between the cells contiguous to every other or alternately (for example, C1 and C3, C2 and C4, and Ck and Ck+2). That is, they are defined as:
the distance between the cells C1 and C3: s1;
the distance between the cells C2 and C4: s2;
the distance between the cells Ck and Ck+2: sk; and
the distance between the cells Cn−2 and Cn: sn−2.

Then, even if there is a missing cell, the conditions for that the “cells” are still traceable are as follows.

<<The Fourth Condition>>

sk≦a2(k=1 to n−2).

First, the fourth condition indicates that the distance between the cells contiguous to every other is not more than the predetermined maximum value a2. If this condition is met, (as long as the other conditions as follows are met) even if there is one missing cell, it is possible to trace the next cell. If this condition is not met, the cell next to the missing cell may be farther than the maximum value a2 from the missing cell and thereby may not meet the requirements for tracing.

Besides, in the above description, the expression “contiguous to every other” was utilized. That refers, however, to the same meaning as the expression “one of the cells and another of the cells between which another of the cells is sandwiched” set forth in the appended claims.

<<The Fifth Condition>>

sk<Dk, Dk+2(k=1 to n−2).

The fifth condition indicates that the distance from Ck which is No. k cell to Ck+2 is shorter than Dk which is the shortest of the distances from the cell Ck to non-cell areas. If this condition is met, supposing the cell Ck is missing, since the distance from the cell Ck (further) to the next cell Ck+2 is shorter than the distances from the cell Ck to non-cell areas, the tracing will yet not be mistakenly directed to non-cell areas.

<<The Sixth Condition>>

If d(m:n) represents the, distance between No. m cell and No. n cell, then,

sk<d(1:k), d(2:k), . . . , d(k−3:k), d(k+3:k), d(k+4:k), . . . , d(n:k).

sk<d(1:k+2), d(2:k+2), . . . , d(k−3:k+2), d(k+4:k+2), d(k+5:k+2), . . . , d(n:k+2).

This condition indicates that the cell Ck+2 contiguous to the cell Ck must be located at a distance shorter than any other cells (from the cell Ck). Thus, in case the cell Ck+1 is missing, as long as this condition is met, (on the premise that the other conditions are also met) it is possible to trace the cells.

In addition, because even the discrete 1D color bit code which allows missing of one cell is still a discrete type, it is necessary to meet the same conditions as required in Embodiment 1.

<<The Seventh Condition>> (The Same as <<The First Condition>>)

In the same manner as the example described with FIG. 1, the inter-cell distance must be between the predetermined minimum value a1 and maximum value a2. That is, it is necessary to meet the condition:

a1≦d1, . . . , dn−1≦a2.

In non-cell areas, the seventh condition is not necessarily met. This condition is the same as the first condition described hereinbefore.

<<The Eighth Condition>> (The Same as <<The Second Condition>>)

The distances D1, . . . , Dn between each cell and the nearest color area which is not of the code symbol must meet either of the following conditions.

(The Eighth Condition a)

D1, . . . , Dn>a2,
or, as another way of thinking,

(The Eighth Condition b)

dk−1, dk≦Dk(k=1 to n).

Both of the conditions indicate that the distance between a cell and a contiguous cell is necessarily shorter than that between the cell and a surrounding non-cell color area, thereby not allowing a mistaken tracing. This condition is in practice the same as the second condition described hereinbefore.

<<The Ninth Condition>> (The Same as <<The Third Condition>>)

The distances dk−1 and dk between No. k cell Ck and the contiguous cells on both sides should meet the following requirements. This condition is the same as the third condition described hereinbefore.

If d(m:n) represents the distance between No. m cell and No n cell, then,

dk−1<d(1:k), d(2:k), . . . , d(k−2:k); and

dk−1<d(k+2:k), . . . , d(n:k).

That is, with respect to the distance between the cell Ck and another cell, the distances between the cell Ck and the cells on both sides must be shorter than those between the cell Ck and any other cells.

The above formula shows the condition that the distance dk−1 is shorter than any other distances except the distance dk. This also applies to the distance dk. As a formula, it is necessary to set up the following one, which is completely the same as the above formula.

dk<d(1:k), d(2:k), . . . , d(k−2:k); and

dk<d(k+2:k), . . . , d(n:k).

To conclude, it is necessary to establish a relationship that distances dk and dk−1 are shorter than those between the cell Ck and any other cells.

If the ninth condition is met, it is possible to carry out tracing in the desired sequence predetermined by the code symbol by tracing the cell over a short distance to restore the code symbol value.

In contrast, if the ninth condition is not met, the correct cell sequence of the code symbol cannot be restored by the process of tracing the cell over a short distance. Thereby, it is possible to recognize the code symbol in a wrong sequence so as to restore a wrong data.

If the above conditions are met in addition to the characteristic of the discrete 1D color bit code described in Embodiment 1, in case any one of the cells is missing, it is still possible to acquire a 1D color bit code with which the data is restorable.

2-2 Number of Missing Cells

With the discrete 1D color bit code which has been described so far, it is possible to trace the cells even if there is a missing cell. Herein, a predetermined error correction technology is utilized to restore or correct the missing cell. Conventionally, there are widely known means of this kind such as CRC and other various correction codes, which may be, therefore, utilized for the purpose.

As has been already described, even in the case of utilizing the existing error correction technology, error correction cannot be carried out if the tracing of cell is not completed. In other words, if one cell is missing, it is necessary to be able to trace all the cells other than the missing one for recognition. Therefore, the embodiment proposes the conditions and method under which the tracing can be completely carried out even if there is a missing cell. Hence, it is with the method of the embodiment that the existing error correction technology can be applied to the 1D color bit code.

Besides, in the descriptions which have been made so far, the number of missing cells is one. However, in the method of the embodiments, there are no specific restrictions of allowable number of missing cells. In other words, the number of correctable missing cells depends on the adopted error correction technology (such as CRC and other error correction codes).

However, the method described in Embodiment 2 is based on the premise that the cells are only discretely missing but not based on the premise that the cells are continuously missing (continuity error: the so-called burst error).

2-3 Conditions for Forming the Discrete 1D Color Bit Code Allowing Missing of Cell

So far, various conditions have been described for the discrete 1D color bit code which allows missing of cell. They are, as the same time, the conditions for successful tracing.

The successful tracing conditions are however a little different from the condition for forming a discrete 1D color bit code in the following aspects.

For example, the aforementioned eighth condition (the same as the second condition) is with respect to a relationship between the discrete 1D color bit code and the surroundings in the marking rather than for the discrete 1D color bit code per se. In this meaning, it can be regarded as, strictly speaking in the same manner as in Embodiment 1, a marking condition.

Likewise, the fifth condition which applies the eighth condition to the distance between every other or alternate cells is also a marking performance condition.

Therefore, the requirements for the discrete 1D color bit code “allowing missing of cell” proposed in the embodiment are as follows, excluding the eighth and fifth conditions (which are considered as marking process conditions).

<<The Fourth Condition>>

The distance between every other or alternate cells should be not more than the maximum value a2. This is a condition which applies the aforementioned first condition to the every other or alternate cells as well.

<<The Sixth Condition>>

Viewing from the cell Ck, except the cell Ck+1, the cell Ck+2 is the nearest cell. Herein, k is an integer from 1 to n−2. This is the condition for the tracing to continue from the cell Ck to the cell Ck+2 in case the cell Ck+1 is missing.

<<The Seventh Condition>>(The Same as the First Condition)

The distance between contiguous cells is not less than the minimum value a1 and not more than the maximum value a2.

<<The Ninth Condition>>(The Same as the Third Condition)

Viewing from the cell Ck, except the cell Ck+1, the cell Ck−1 is the nearest cell. In the same manner, viewing from the cell Ck, except the cell Ck−1, the cell Ck+1 is the nearest cell. k is an integer from 2 to n−1.

This condition indicates, in a word, that the second nearest cells to the cell Ck are Ck−1 and Ck+1. That is, it indicates that cells which should be connected to a cell are the two nearest cells. Herein in addition, there is a premise that Ck is not an end cell. An end cell is connected to the nearest cell and thus has no direct relations with the third condition.

2-4 Reading-Out Process Flow

Generally, the process flow as below is followed to read out the discrete 1D color bit code formed or marked under the above conditions.

Step 1: Capturing (imaging) an image including a code symbol.

Step 2: Regionalizing the obtained image data into each color based on the colors.

Step 3: Tracing the areas of marking colors utilized in the code symbol to extract the connecting relation of each area, wherein the tracing is carried out based on the distance between the areas, and the color areas are traced on the premise that the areas within the range from the minimum value a1 to the maximum value a2 are contiguous areas.

In the tracing, considering that there may be missing of cell, even if the number of cells is unanticipated (the number of cells is smaller), these cells are still considered as optical code candidates.

Step 4: Determining from the tracing result which areas compose the code on the basis of the colors utilized in the code, the extracted or identified connecting relation of each color area (the number of cells), and the like.

Herein, considering that there may be missing of cell, even if the number of cells per se is less than anticipated, as long as the other requirements are met, these cells are determined as of the optical code.

From the color areas which are determined as of the optical recognition code, the color alignment is extracted so as to restore the original data therefrom.

### Embodiment 3

### About the Distance Between Cells or the Distance Between Color Areas

So far, it has been proposed that distance between the centroids of each area, minimum interspace between the respective areas and the like be utilized as the “distance”.

3-1 Setting a Basing Point in each Area and Defining the Distance Between the Basing Points as the “Inter-Area Distance”.

FIG. 4 shows an explanatory diagram of other types of distance. As shown in FIG. 4, such a method is conceivable as to set a basing point in each color area (or cell) and then define the distance between the basing points as the “inter-area distance”, respectively. FIG. 4 shows, for example, the distance GaGb between the centroid Ga of the area A and the centroid Gb of the area B, and the distance GbGc between the centroid Gb of the area B and the centroid Gc of the area C.

Of course, there are various methods for setting a basing point other than taking centroids as basing points. These are some representative preferred examples : centroidal or centroid positions of areas, midpoints of the maximum extensions in the respective directions x and y, and the like.

3-2 Defining by Position or Shape of each Area.

As shown in FIGS. 5 and 6, there are methods of defining the distance by the interrelation between the positions and shapes of areas without setting a basing point for each color area (or cell).

For example, FIG. 5 shows an idea of defining the “distance” as a “minimum interspace” between areas. In FIG. 5, the minimum interspace tAB between the areas A and B is illustrated as well as the minimum interspace tBC between the areas B and C.

In addition, a minimum interspace refers to the shortest of the distances between any pixel of the area A and any pixel of the area B.

Further, as shown in FIG. 6, it is also preferred, as a method, to define the “distance” as an “average interspace” between areas. As shown in FIG. 6, a band with a width of a predetermined value Z is provided between the areas A and B, and an average distance of the band is sought between the side tangent to the area A and the side tangent to the area B. This average distance is the average interspace between the areas A and B. Further in the same manner, a band with a width of the predetermined value Z is provided between the areas B and C, and an average distance of the band is sought between the side tangent to the area B and the side tangent to the area C. This average distance is the average interspace between the areas B and C.

Herein, the predetermined value Z may be preferably determined by human in a heuristic manner or be the value of the square root of the area of each area multiplied by a certain coefficient (0.6, 0.5, and the like).

Further, it is preferred to form the calculation area of interspace average value by widening the line segment connecting the centroid of each area respectively by Z/2. Further, it is also preferred to widen the line segment connecting the centroid of each area to such an extent as to completely cover up any one of the areas and then utilize that area as the calculation area of interspace average value.

3-3 Relationship Between the Definition of Distance and the Various Conditions Described Above

(3-3-a) The Definition of Distance with the Basing Point as a Standard

Now, in Embodiments 1 and 2, the condition for inter-cell distance is defined beforehand as:

a1≦d1, . . . , dn−1≦a2

Herein, a1 is the minimum value of distance between cells, and a2 is the maximum value of distance between cells. This method is, as shown in FIG. 4, especially effective for the case of defining a basing point and then adopting the distance between the basing points as the inter-cell distance.

The reason is that in the cases such as shown in FIG. 4 and the like, stipulating the minimum value a1 can obtain an almost equivalent effect to that of stipulating the minimum value of cell size, and thereby there is a high possibility that color areas below a certain level (of size) can be excluded as non-cells.

Further, when an image is drawn on CAD, a reference point of drawing is often determined, and the reference point is regarded as the image position. In such a case, it is also preferred to adopt the reference point of drawing as the aforementioned “basing point”.

(3-3-6) Definition of the Distance Based on Shape and the Like

On the other hand, in the method of utilizing the interspace as the “inter-cell distance”, it is anticipated that a sufficiently effective result can be acquired at a comparatively high rate by (only) stipulating the maximum value a2. This is because with the maximum value being determined, what is needed to do is to search for a cell which should be traced next within that range. Further, when the minimum value a1 is not stipulated, it becomes, of course, zero, thereby resulting only in a zero interspace. This is because it becomes the same as the conventional 1D color bit code.

Therefore, when the interspace, average interspace, and the like are utilized as the distance, only stipulating the maximum value a2 can also be effective.

In addition, in such a case as only the maximum value a2 is stipulated and the minimum value a1 is not, sometimes minute color areas may also need to be excluded as noises. In this case, it is conceivable that similar effect can be acquired by providing an algorithm for canceling minute color areas (the same as a common noise canceling method) other than stipulating the minimum value a1.

It is preferred to selectively apply an optimum method on a case by case basis: either to stipulate a nonzero minimum value a1 or otherwise to provide an algorithm of canceling minute areas.

### Embodiment 4

### Prohibition (Prevention) of Circular Reading-Out at End Points

When color areas are traced under the various conditions illustrated in the methods described so far, it is conceivable that the tracing does not stop at the end points but reconnects a cell. That is, another cell is located in the vicinity of the cell which should be the end point, and the distance between them is not more than the maximum value a2.

In such a case, the tracing will be restarted in the direction of “the other cell”. Thereby, it is possible to result in being unable to read out the code or markedly degrading the reliability of data.

In order to prevent this, it is preferred to provide the following condition.

<<The Tenth Condition>>

The distances between the cell which serves as an end point and all the color areas other than the only cell which is connected to the end point cell should all be more than the maximum value a2.

In other words, the cell which is connected to the end point cell is the only cell or the only color area (to which a predetermined marking color is affixed) which is located at a distance of not more than a2 from the end point cell.

FIG. 7 shows an explanatory diagram of such a condition. As shown in FIG. 7, the cell C1 is connected to the end point cell Cm. Then, the cell Cd is the second nearest cell to the end point cell Cm, and the distance GdGm between the cells Cm and Cd is over the maximum value a2. Herein, the distance is defined on the centroid basis. However, it is also preferred to adopt other basing points than centroid as the standard. Further, values of the interspace, average interspace and the like determined from the shape and the like of color areas may also be utilized as the distance.

By adding such a condition, at the end point where the tracing should be terminated, it is possible to assuredly terminate the tracing of cells.

So far, explanations have been given on the discrete 1D color bit code which meets the various conditions. At any rate, if confirmations are made to confirm the existence of the two endpoints with the conditions as described in Embodiment 4, and further to confirm the number of the component cells and the rule of alignment, etc., it is possible to check whether the area group composes the code symbol or not.

### Embodiment 5

### Modifications and the Like

(1) In the embodiments described above, in order to keep a compatibility with the conventional 1D color bit codes, different colors must be affixed to continuous areas.

However, the discrete 1D color bit code stipulates the range of connected areas by distance (the minimum value a1 and the maximum value a2). Therefore, supposing there are detected two continuous areas to which an identical color is affixed, those two areas are regarded collectively as one area.

However, as described above, since the discrete 1D color bit code stipulates the range of connected areas by distance, often an identical color is also allowed to be affixed to contiguous color areas.

Thus, although the code system becomes different from the conventional 1D color bit code, it is also preferable to adopt a code system which allows an identical color to be affixed to contiguous color areas.

(2) With a mark object marked with the optical recognition code described so far, the optical recognition code thereon can be read out by the tracing based on the distance. Thereby, it is possible to easily read out the denotation data.

### BRIEF DESCRIPTION OF THE DRAWINGS

FIG. 1 is an explanatory diagram showing an example of a discrete 1D color bit code in accordance with embodiments of the present invention;

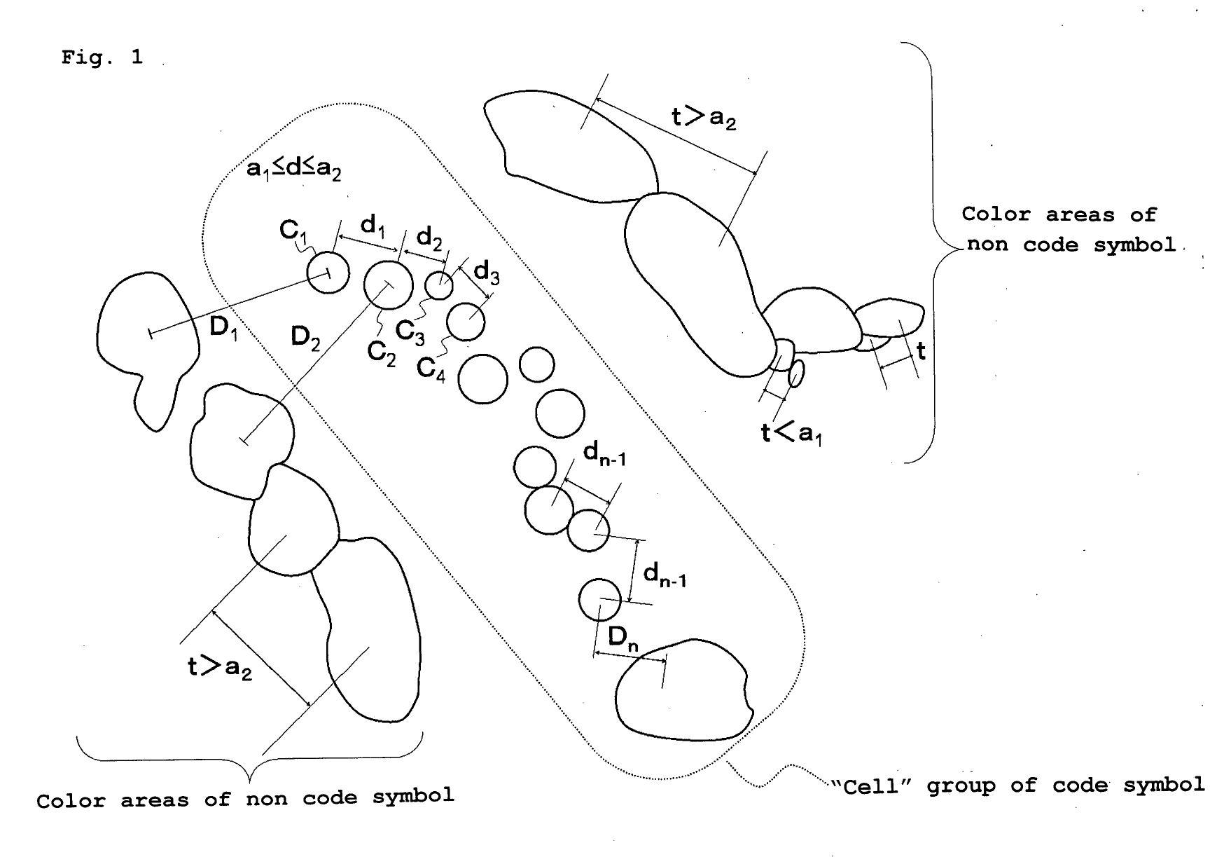

FIG. 2 is an explanatory diagram of an example that one cell is missing in a reading-out process in accordance with the embodiments;

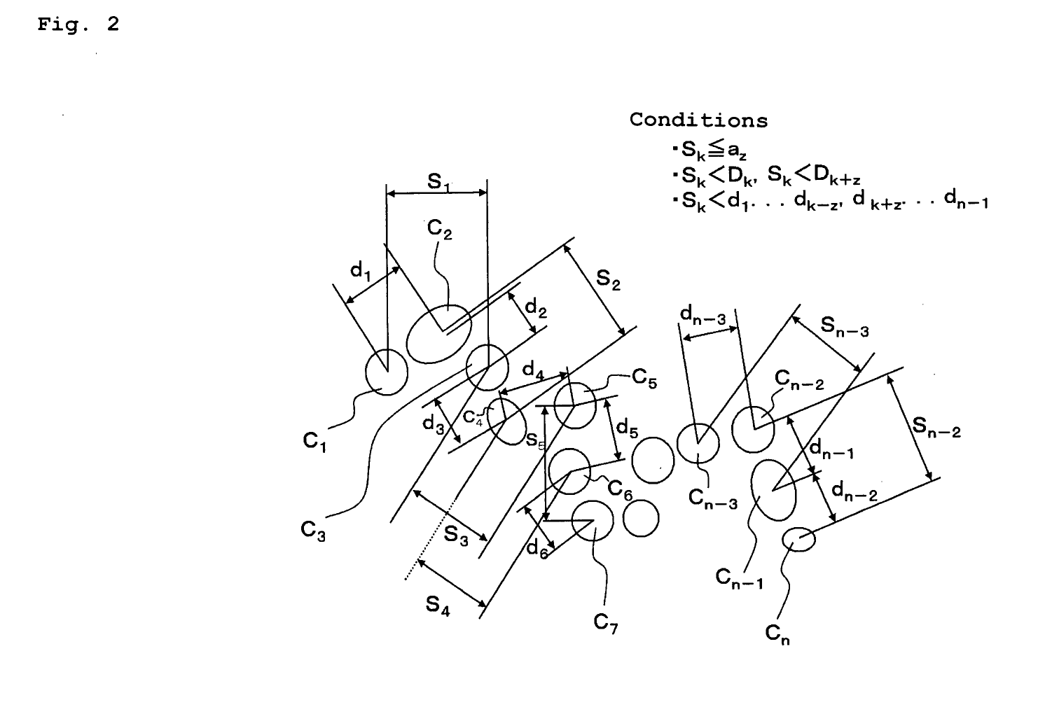

FIG. 3 is an explanatory diagram of another example that one cell is missing in a reading-out process in accordance with the embodiments;

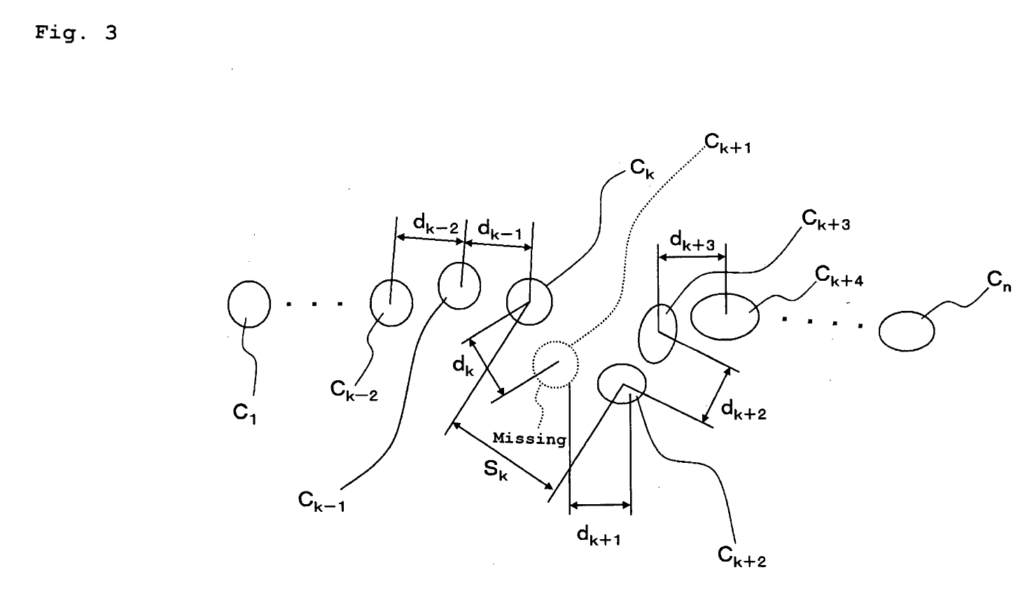

FIG. 4 is an explanatory diagram of other types of distance;

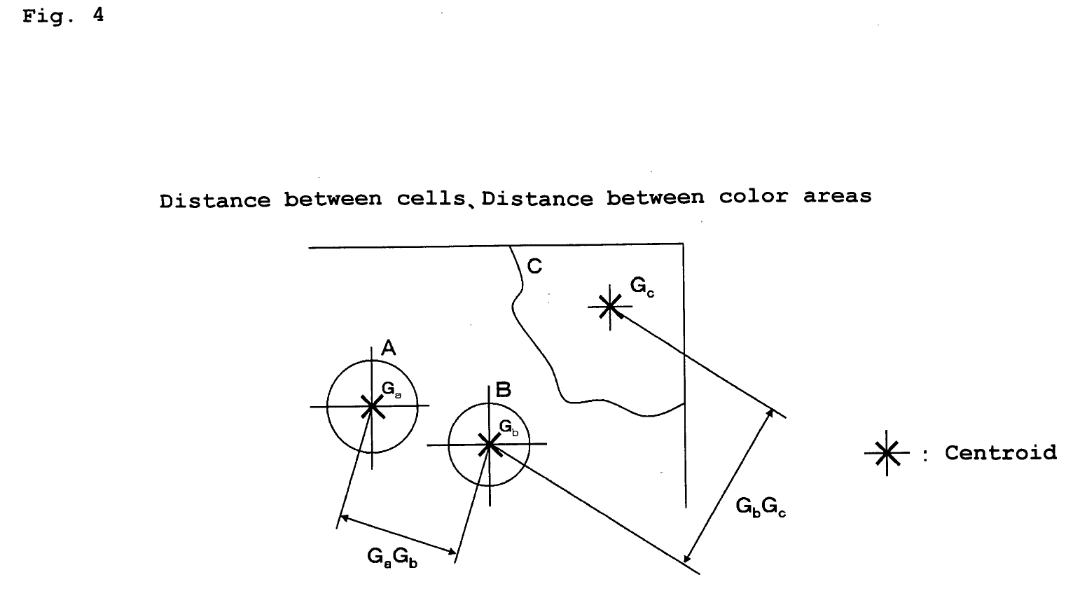

FIG. 5 is an explanatory diagram showing an example of defining a distance as a minimum interspace between areas;

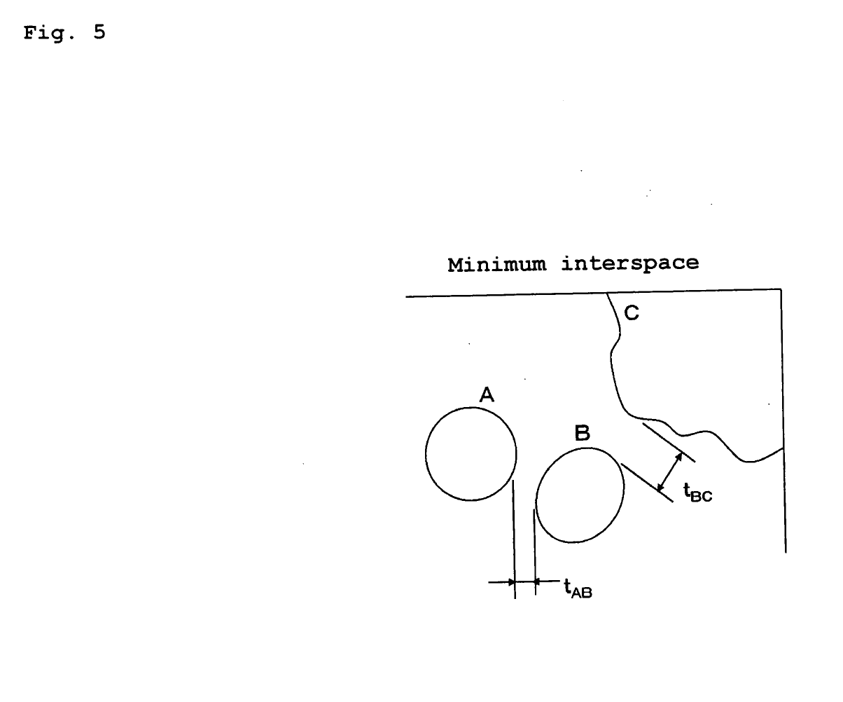

FIG. 6 is an explanatory diagram showing an example of defining the distance as an average interspace between areas; and

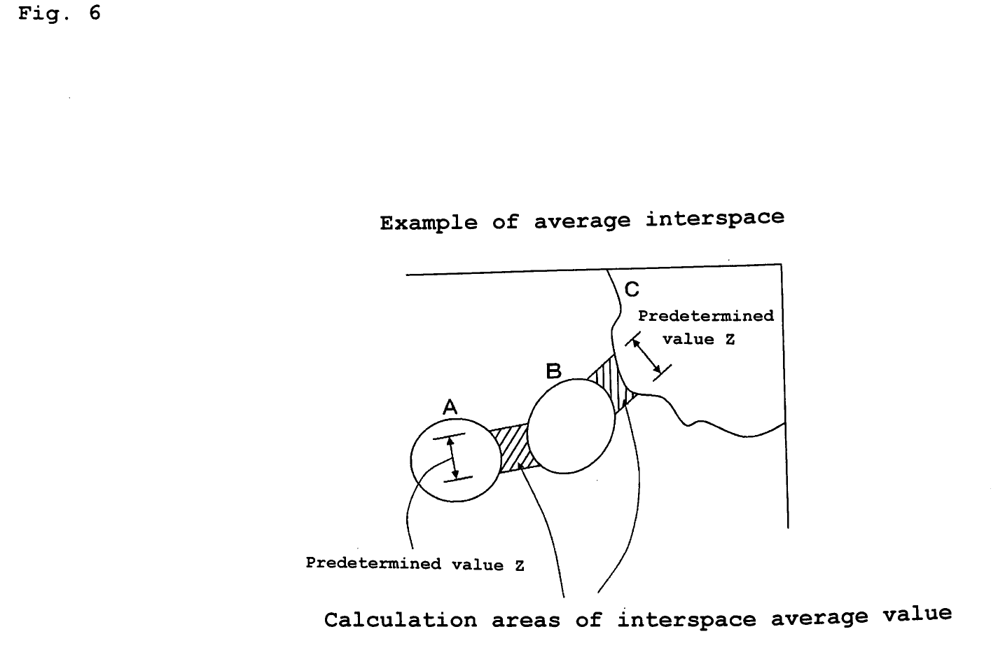

FIG. 7 is an explanatory diagram for explaining a condition for preventing circular reading.

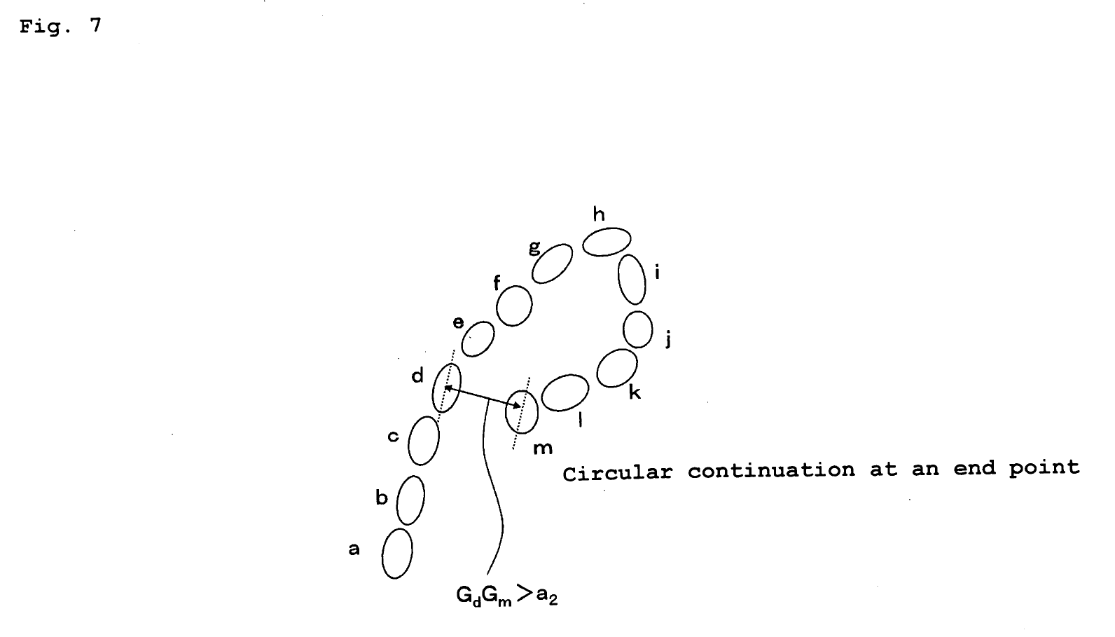

### REFERENCE NUMERALS

a1 Minimum distance between cells

a2 Maximum distance between cells

Ck Cell (k is an integer of 1, . . . , n)

dk Distance between the cell Ck and the cell Ck+1 (k is an integer of 1, . . . , n)

Sk Distance between the cell Ck and the cell Ck+2 (k is an integer of 1, . . . , n)

Ga Centroid of the area A

Gb Centroid of the area B

Gc Centroid of the area C

GaGb Distance between the centroids of the areas A and B

GbGc Distance between the centroids of the areas B and C

tAB Minimum interspace between the areas A and B

tBC Minimum interspace between the areas B and C

1. An optical recognition code disposing a plurality of cells to each of which a predetermined color is affixed and denoting a data by a sequence of the colors affixed to the cells, wherein a distance between the cells contiguous to each other is more than or equal to a predetermined minimum value and less than or equal to a predetermined maximum value; and the distance between one of the cells and another of the contiguous cells is shorter than a distance between the one of the cells and another of the noncontiguous cells.

2. An optical recognition code disposing a plurality of cells to each of which a predetermined color is affixed and denoting a data by a sequence of the colors affixed to the cells, wherein a distance between the cells contiguous to each other is more than or equal to a predetermined minimum value and less than or equal to a predetermined maximum value; and a distance between one of the end point cells located at either of the two ends of the optical recognition code and another of the noncontiguous cells is more than the predetermined maximum value.

3. An optical recognition code disposing a plurality of cells to each of which a predetermined color is affixed and denoting a data by a sequence of the colors affixed to the cells, wherein a distance between the cells contiguous to each other is more than or equal to a predetermined minimum value and less than or equal to a predetermined maximum value; the distance between one of the cells and another of the contiguous cells is shorter than a distance between the one of the cells and another of the noncontiguous cells; and a distance between one of the cells and another of the cells between which yet another of the cells is sandwiched is less than or equal to the predetermined maximum value and shorter than a distance between the one of the cells and another of the noncontiguous cells.

4. The optical recognition code according to claim 1, wherein the minimum value and the maximum value are provided by an absolute dimension or a relative dimension.

5. A method for marking a mark object with the optical recognition code according to claim 1, the method comprising the step of disposing the optical recognition code on the mark object at such a position that a minimum distance between any of the plurality of cells which compose the optical recognition code and a color area which does not compose the optical recognition code on the mark object becomes more than the predetermined maximum value.

6. The optical recognition code according to claim 1, wherein the distance between the cells is a minimum interspace between the cells, respectively.

7. The optical recognition code according to claim 1, wherein the distance between the cells is an average interspace between the cells, respectively.

8. The optical recognition code according to claim 1, wherein the distance between the cells is a distance between basing points of the cells, respectively.

9. A method for reading out the optical recognition code according to claim 1, the method comprising the steps of:
(a) imaging an image including the optical recognition code and obtaining an image data; and
(b) dividing the obtained image data into color areas of each color, extracting based on color the color areas which are candidates of the cells composing the optical recognition code from the color areas, tracing the extracted candidates of the cells based on the distance therebetween, and restoring the data denoted by the optical recognition code based on the sequence of the cells obtained from the tracing result,
wherein in step (b), when the color areas of an identical color are continuously aligned, they are considered as to form a single one of the cells.

10. The optical recognition code according to claim 1, wherein the number of the cells composing the optical recognition code is predetermined.

11. The method for marking a mark object with the optical recognition code according to claim 5, wherein the distance between the cells is a minimum interspace between the cells, respectively.

12. The method for marking a mark object with the optical recognition code according to claim 5, wherein the distance between the cells is an average interspace between the cells, respectively.

13. The method for marking a mark object with the optical recognition code according to claim 5, wherein the distance between the cells is a distance between basing points of the cells, respectively.

14. The method for reading out the optical recognition code according to claim 9, wherein the distance between the cells is a minimum interspace between the cells, respectively.

15. The method for reading out the optical recognition code according to claim 9, wherein the distance between the cells is an average interspace between the cells, respectively.

16. The method for reading out the optical recognition code according to claim 9, wherein the distance between the cells is a distance between basing points of the cells, respectively.

17. An article being marked with the optical recognition code according to claim 1.
